(19) United States
(12) Patent Application Publication
(10) Pub. No.: US 2026/0366480 A1
(43) Pub. Date: Nov. 19, 2026

(54) SYSTEMS AND METHODS FOR ADJUSTING IGNITION ASSIST DEVICE PARAMETERS BASED ON ZERO-CARBON FUEL SUBSTITUTION

(71) Applicant: CUMMINS INC., Columbus, IN (US)

(72) Inventors: Lyle E. Kocher, Whiteland, IN (US); j. Steven Kolhouse, Columbus, IN (US); Daniel J. O'Connor, Columbus, IN (US); Hui Xu, Carmel, IN (US)

(73) Assignee: CUMMINS INC., Columbus, IN (US)

(21) Appl. No.: 19/135,794

(22) PCT Filed: Dec. 5, 2022
(86) PCT No.: PCT/US2022/051782

§ 371 Date: Jun. 4, 2025

(51) Int. Cl. F02P 5/04; F02D 35/02; F02D 41/00; F02D 41/40; F02P 5/152

(52) U.S. Cl. CPC F02P 5/045; F02D 35/027; F02D 41/0025; F02D 41/40; F02P 5/1527; F02D 2200/1015

(57) ABSTRACT

A system, method, and apparatus for controlling at least one ignition assist device based on a fueling characteristic of an engine are provided. A system includes at least one ignition assist device coupled to a controller. The controller is configured to: receive fuel data for an engine coupled to the at least one ignition assist device, the fuel data comprising a value regarding at least one of a first fuel or a second fuel for the engine, the first fuel differing from the second fuel; determine that the value regarding the at least one of the first fuel or the second fuel is greater than a predefined threshold; and adjust at least one parameter of the at least one ignition assist device based on the determined value being greater than the predefined threshold.

### TECHNICAL FIELD

The present disclosure relates to managing, monitoring, and controlling engine ignition. More particularly, the present disclosure relates to adjusting one or more parameters of at least one ignition assist device based on fueling characteristics for an engine.

### BACKGROUND

Spark-ignition (SI) engines rely on an ignitor (e.g., a spark plug, etc.) to initiate combustion of an air-fuel mixture inside a combustion chamber (e.g., cylinder). The chemical energy produced during combustion can be used to power a vehicle, a generator set (i.e., a genset), or another system utilizing the SI engine. The performance of the SI engine can vary greatly depending on many parameters, such as the quality of the fuel and characteristics relating to the ignitor. For example, fouling (particulate build-up, such as from dirt and oil) on the ignitor can lead to the ignitor not working as intended (e.g., not sparking, not sparking for as long as desired, etc.). As another example, lower quality fuel may be difficult to combust thereby leading to combustion problems with the engine.

Therefore, tracking parameters affecting performance of the SI engine, such as those relating to the ignitors, is beneficial to help mitigate circumstances that may lead to undesirable performance.

### SUMMARY

One embodiment relates to a system. The system includes at least one ignition assist device and a controller coupled to the at least one ignition assist device. The controller is configured to receive fuel data for an engine coupled to the at least one ignition assist device, the fuel data comprising a value regarding at least one of a first fuel or a second fuel for the engine, the first fuel differing from the second fuel. The controller is configured to determine that the value regarding the at least one of the first fuel or the second fuel is greater than a predefined threshold. The controller is configured to adjust at least one parameter of the at least one ignition assist device based on the determined value being greater than the predefined threshold.

Another embodiment relates to a method. The method includes receiving, by a controller coupled to an ignition assist device, fuel data for an engine coupled to the ignition assist device, the fuel data comprising a value regarding at least one of a first fuel or a second fuel for the engine, the first fuel differing from the second fuel. The method includes determining, by the controller, that the value regarding the at least one of the first fuel or the second fuel is greater than a predefined threshold. The method includes adjusting, by the controller, at least one parameter of the ignition assist device based on the determined value being greater than the predefined threshold.

Still another embodiment relates to an apparatus. The apparatus includes one or more processors, and one or more memory devices coupled to the one or more processors. The one or more memory devices store instructions that, when executed by the one or more processors, cause the one or more processors to receive fuel data for an engine coupled to an ignition assist device, the fuel data including a value regarding at least one of a first fuel or a second fuel for the engine, the first fuel differing from the second fuel. The instructions, when executed by the one or more processors, further cause the one or more processors to determine that the value regarding the at least one of the first fuel or the second fuel is greater than a predefined threshold. The instructions, when executed by the one or more processors, still further cause the one or more processors to adjust at least one parameter of the ignition assist device based on the determined value being greater than the predefined threshold.

These and other features, together with the organization and manner of operation thereof, will become apparent from the following detailed description when taken in conjunction with the accompanying drawings. Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE FIGURES

FIG. 1 is a schematic diagram of a system including a piston-cylinder system communicatively coupled to a controller, according to an example embodiment

FIG. 2 is a schematic diagram of a larger system for the system of FIG. 1 including an engine-exhaust aftertreatment system coupled to the controller, according to an example embodiment.

FIG. 3 is a schematic diagram of the controller of FIGS. 1-2, according to an example embodiment.

FIG. 4 is a flow diagram of a method for adjusting at least one parameter of an ignition assist device based on fueling characteristics for an engine using the controller of FIGS. 1-3, according to an example embodiment.

### DETAILED DESCRIPTION

Following below are more detailed descriptions of various concepts related to, and implementations of, methods, apparatuses, and systems for controlling ignition assist devices for engines. The various concepts introduced above and discussed in greater detail below may be implemented in any number of ways, as the concepts described are not limited to any particular manner of implementation. Examples of specific implementations and applications are provided primarily for illustrative purposes.

Referring to the Figures generally, the various embodiments disclosed herein relate to systems, apparatuses, and methods for adjusting and/or controlling at least one parameter of at least one ignition assist device of an engine (e.g., based on a hydrogen fuel substitution rate for the engine). The engine may be a SI engine. As described herein, the SI internal combustion engine can use at least one certain type of fuel as the primary/main/first fuel for combustion within the combustion chamber or cylinder of the engine. For example, the engine can be configured to use natural gas as the primary fuel for combustion. The fuel is delivered into the combustion chamber via an injector that may be positioned upstream of the chamber (e.g., delivering natural gas in a fumigated manner via intake piping or throttle injection) or may be positioned within the chamber of the engine. The natural gas fuel may be in the form of compressed natural gas (CNG), liquefied petroleum gas (LPG), liquefied natural gas (LNG), BioGas, among others. In some embodiments, the natural gas fuel may be pure or substantially pure propane, methane, and/or butane. For simplicity and for the purposes of providing examples, natural gas fuel can be the primary fuel type for the engine, however, other types of fuels (or other types of engines) may also be used for the technical solution discussed herein. In this regard, the SI engine may selectively use another fuel for combustion. This second fuel can also be introduced into the engine and mixed or blended with the primary fuel. In one embodiment, this other fuel type can be hydrogen fuel, which can supplement (or be mixed with) natural gas to generate power from the engine. In another embodiment, the engine may be solely powered by hydrogen fuel. In another embodiment, the second fuel may be different from pure hydrogen, such as ammonia, a hydrogen-ammonia mix, or another fuel or fuel additive with the primary fuel. In this regard, the two (or more) fuel types may have significantly different individual combustion characteristics, but both are flammable and both represent a way to substitute zero-carbon fuels (the second fuel, such as H2 and/or NH3) for low carbon fuels (CH4 or C3H8). Moreover and beneficially, in some arrangements, ammonia may be on-board the system (e.g., in a vehicle application that stores ammonia for reductant dosing purposes). In this situation, utilization of ammonia may be relatively easy as a fuel (e.g., via addition of a fuel line and injector for the ammonia to be used as a fuel). The hydrogen fuel may be utilized to reduce certain types of emissions or byproducts (e.g., carbon dioxide (CO2) emission) from the engine. For instance, while natural gas is a low-carbon fuel, hydrogen is a no-carbon fuel, thereby reducing the overall CO2 production from the natural gas engine. Hydrogen fuel may be delivered via at least one of a port fuel injection (PFI) (e.g., upstream of the chamber), direct in-cylinder injection (DI) (e.g., inside the chamber), duel injection (e.g., both inside and outside the chamber), or among other manners. Depending on the mixture of hydrogen with natural gas, an engine knock or combustion misfire of the engine may occur due to the difference in combustibility of hydrogen (e.g., easier to ignite or combust) compared to natural gas. Alternatively, when hydrogen is used by itself, the high combustibility of hydrogen may also cause undesired combustion circumstances, such as knock.

The systems and methods of the technical solution described herein monitor, identify, receive, or otherwise determine a value or characteristic value (e.g., amount, the ratio of the mixture, fuel pressure, etc.) regarding the fuel(s) entering the combustion chamber to adjust or control at least one ignition parameter of at least one ignition assist device of the engine to reduce or mitigate a likelihood of an engine knock or another misfire condition, minimize energy output (e.g., reduce ignition energy to extend a life of the ignition assist device), and improve the ignition timing. Thus, the systems and methods described herein improve overall performance of the engine system. In some embodiments, the systems and methods described herein can determine the value of the fuel(s) to control the dosage of reductant for an aftertreatment system, thereby minimizing overdosing of the reductant or under-dosing the reductant to assist with overall engine emissions. In turn and beneficially, the systems and methods described herein can assist with improved engine emissions as well as improved engine performance and operation.

As discussed herein, the engine includes at least one ignition assist device associated with a respective combustion chamber. The ignition assist device can include or be at least one of an in-cylinder ignitor (e.g., spark plug), a pre-chamber ignitor, among other ignition assist devices to name a few. A controller may control the ignition parameters of the ignition assist device. The ignition parameters can include at least one of an ignition energy, an ignition (or spark) timing, an ignition profile (e.g., a single spark or multi-spark command), etc. As referred herein, the “ignition energy” refers to the current and/or voltage provided to the ignitor, which affects the output from the ignitor, such as a spark if embodied as a spark plug. Controlling the voltage and/or current enables control over various ignition parameters, such as a duration of a spark, when the spark is initiated, how many sparks are initiated within a time period or cycle (e.g., an ignition profile), and so on. In this regard, an “ignition profile” refers to the characteristics of the spark within a combustion event, such as commanding a single-spark, commanding a multi-spark, and the timing between the commanded multi-sparks.

In some embodiments, an aftertreatment system may be coupled to the engine. The components in aftertreatment systems may be structured or configured to reduce byproducts (e.g., CO2, NOx, soot, etc.) of the exhaust gas and include, for example, a Selective Catalytic Reduction (SCR) system that utilizes a two-step process to reduce harmful NOx emissions present in exhaust gas and an oxidation catalyst to filter or oxidize hydrocarbon, carbon monoxide, or unburned fuel and oil. Referring to the SCR first, a doser injects a reductant into the exhaust stream. This reductant may be a urea, diesel exhaust fluid (DEF), Adblue®, a urea water solution (UWS), an aqueous urea solution (e.g., AUS32, etc.), or another similar fluid that chemically binds to particles in the exhaust gas. The reductant may decompose to ammonia (NH3) post-injection. Then, this mixture is run through an SCR catalyst that, when at a certain temperature, causes a reaction in the mixture that converts the harmful NOx particles into pure nitrogen and water. In operation, non-decomposed reductant and non-reacted ammonia may be stored within the catalyst (e.g., SCR catalyst) to be chemically reacted with the exhaust product (e.g., NOx particles, etc.). Ammonia that passes through the aftertreatment system and emitted to the environment is known as “ammonia slip.” The systems and methods described herein may be utilized to control the reductant dosing based on the fueling characteristics to improve operation of the aftertreatment system.

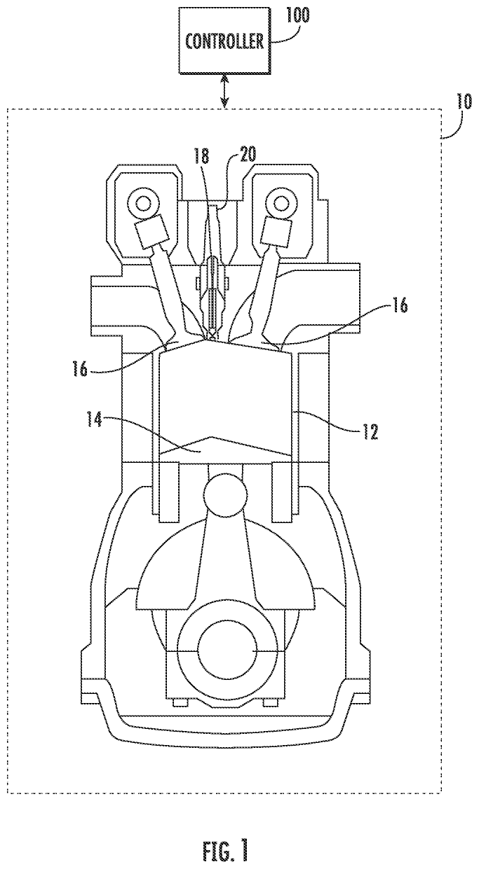

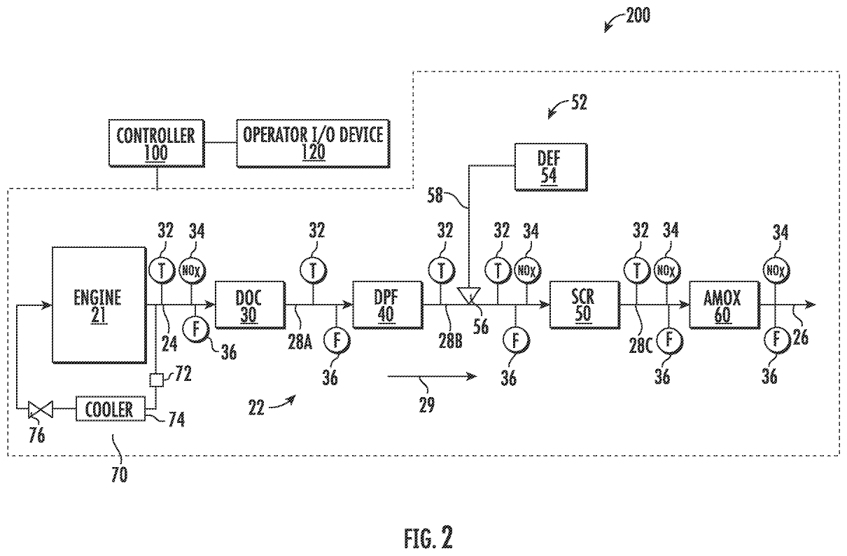

Referring now to FIGS. 1-2 collectively, depicted is a schematic diagram of a piston-cylinder configuration 10 communicatively coupled to a controller 100 (FIG. 1) and an engine-exhaust aftertreatment system 200 (FIG. 2), according to example embodiments. The piston-cylinder configuration 10 may be a part of the engine 21 of the system of FIG. 2.

With reference to primarily FIG. 1 first, as shown, the piston-cylinder configuration 10 includes a cylinder 12, a piston 14 disposed in the cylinder 12, one or more valves 16 (e.g., intake valve(s) or exhaust valve(s)), a fuel injector 18, and an ignition assist device 20. The controller 100 is configured to control one or more operations of one or more components of the piston-cylinder configuration 10, among other components of the engine 21 and system 200. The piston 14 may be coupled to a crankshaft via a connecting rod that rotates upon combustion in the engine to power the system (e.g., move the vehicle, generate electrical energy in a generator application, etc.). The piston 14 and cylinder 12 may have a variety of structural configurations, be constructed from a variety of material types, and include other components than depicted in FIG. 1 (e.g., piston rings, cylinder liners, sensors, etc.).

In FIG. 1, the piston 14 is at bottom dead center in the cylinder 12, such as during or as a result of an intake stroke. For example, a 4-stroke engine includes an intake stroke, a compression stroke, a power/combustion stroke, and an exhaust stroke. During the intake stroke, at least one valve 16 (e.g., intake valve(s)) is open to allow the air-fuel mixture to enter the combustion chamber of the cylinder 12, as the piston 14 moves toward the bottom of the cylinder 12 (e.g., bottom dead center (BDC)). During the compression stroke (e.g., as piston 14 moves toward the top dead center where fuel injector 18 is located), the valves 16 are closed to allow compression of the air-fuel mixture. During the power stroke, the ignition assist device 20 ignites/fires/initiates a spark to generate an explosion force via reaction with the air-fuel mixture, thereby forcing the piston 14 to move toward the bottom of the cylinder 12. During the exhaust stroke (e.g., as piston 14 moves toward the top dead center), at least one valve 16 (e.g., exhaust valve(s)) is opened to allow generated gases to escape via the exhaust pipe or exhaust conduit to the exhaust aftertreatment system.

In some implementations, the fuel mixture is provided inside the combustion chamber of the cylinder 12, such as by at least one fuel injector (e.g., the fuel injector 18 shown in FIG. 1). In some cases, the fuel injector 18 may be located upstream from the combustion chamber, such that the fuel enters the combustion chamber during the intake stroke of the cylinder 12. The combustion chamber refers to the volume (e.g., space) inside the cylinder 12 where the piston 14 is disposed and where combustion occurs. In various arrangements, there may be one fuel injector 18 connected to two fuel tanks or reservoirs containing different fuel types. In some embodiments, there may be more than two types of fuels used for combustion or only a single type of fuel (in addition to air).

As discussed herein, the controller 100 is configured to control one or more parameters of the ignition assist device including ignition energy, ignition timing, ignition profile (e.g., single-spark, multi-spark, timing between each spark of the multi-spark, etc.), among others, such as based on a characteristic regarding the fuel(s) for the engine (e.g., a ratio of different fuel types). Additionally or alternatively, the controller 100 is configured to control one or more parameters of the fuel injector 18 including, but not limited to, an injection timing (when one or both of the fuels are injected to form the charge for combustion), an injection amount of one or both of the fuels, a combination thereof, and so on. Further, the controller 100 is configured to control one or more other components discussed herein to improve the remaining useful life of the ignition assist device and minimize combustion misfire or engine knock based on the fuel mixture.

Referring more particularly to FIG. 2 and as shown, the system 200 includes an internal combustion engine 21 having the piston-cylinder system 10, an exhaust aftertreatment system 22 that is in exhaust gas-receiving communication with the engine 21, and an operator input/output (I/O) device 120 that is coupled to the controller 100. In the example shown, the system 200 is embodied in a vehicle. The vehicle may be an on-road or an off-road vehicle including, but not limited to, line-haul trucks, mid-range trucks (e.g., pick-up trucks), cars, boats, tanks, airplanes, locomotives, mining equipment, and any other type of vehicle. The vehicle may include a transmission, a fueling system, one or more additional vehicle subsystems, etc. In this regard, the vehicle may include additional, less, and/or different components/systems than shown, such that the principles, methods, systems, apparatuses, processes, and the like of the present disclosure are intended to be applicable with other vehicle configuration. It should also be understood that the principles of the present disclosure should not be interpreted to be limited to vehicles; rather, the present disclosure is also applicable with stationary pieces of equipment such as a power generator or genset. For example, hydrogen may be delivered via a pipeline to the stationary or primarily stationary engine for combustion. In some embodiments, the vehicle may be another type of vehicle, such as a hybrid vehicle containing one or more electric motors, a fuel cell vehicle, and so on.

In the example shown, the engine 21 is an internal combustion engine that is structured as a spark-ignition internal combustion engine that utilizes natural gas, or other types of fuels used with SI engines. In this regard and in various other embodiments, the engine 21 may utilize other fuel types, such as hydrogen. For the purposes of providing examples herein, the engine 21 may utilize at least one or a combination of two or more fuel types, such as natural gas and hydrogen. In some cases, the engine 21 may be structured to operate with more than two types of fuel or less than two types of fuel. In various arrangements, other fuel types can be used for the engine 21 in addition to or in place of the natural gas and/or hydrogen. In certain implementations, the engine 21 may be coupled with a first fuel source (e.g., first tank) providing a first type of fuel to operate the engine 21 (e.g., natural gas) and a second fuel source (e.g., second tank) providing a second type of fuel for the engine 21 (e.g., hydrogen).

Within the internal combustion engine 21, air from the atmosphere is combined with at least one of the first or second fuels and combusted to power the engine. Combustion of the fuel(s) and air in the compression chambers of the engine 21 produces exhaust gas that is operatively vented to an exhaust manifold (not shown) and subsequently to the aftertreatment system 22.

In this embodiment, the engine is coupled to an exhaust aftertreatment system 22. The exhaust aftertreatment system 22 includes a particulate filter (PF) 40, an oxidation catalyst (OC) 30, a selective catalytic reduction (SCR) system 52 with an SCR catalyst 50, an ammonia oxidation (AMOx) catalyst 60, and an exhaust gas recirculation (EGR) system 70. The SCR system 52 further includes a reductant delivery system that has a reductant fluid source 54 that supplies reductant to a doser 56 via a reductant line 58. In this way, the components and systems of the aftertreatment system 22 may be similar to diesel engine exhaust gas aftertreatment systems.

In an exhaust flow direction, as indicated by directional arrow 29, exhaust gas flows from the engine 21 into inlet piping 24 of the exhaust aftertreatment system 22.

From the inlet piping 24, the exhaust gas flows into the oxidation catalyst 30 and exits the oxidation catalyst into a first section of exhaust piping 28A. From the first section of exhaust piping 28A, the exhaust gas flows into the particulate filter 40 and exits the particulate filter into a second section of exhaust piping 28B. From the second section of exhaust piping 28B, the exhaust gas flows into the SCR catalyst 50 and exits the SCR catalyst into the third section of exhaust piping 28C. As the exhaust gas flows through the second section of exhaust piping 28B, it is periodically dosed with reductant by the reductant doser 56. Accordingly, the second section of exhaust piping 28B acts as a decomposition chamber or tube to facilitate the decomposition of the reductant to ammonia. From the third section of exhaust piping 28C, the exhaust gas flows into the AMOx catalyst 60 and exits the AMOx catalyst into outlet piping 26 before the exhaust gas is expelled from the system 22. Based on the foregoing, in the illustrated embodiment, the oxidation catalyst 30 is positioned upstream of the particulate filter 40 and the SCR catalyst 50, and the SCR catalyst 50 is positioned downstream of the particulate filter 40 and upstream of the AMOx catalyst 60. However, in alternative embodiments, other arrangements of the components of the exhaust aftertreatment system 22 are also possible.

The oxidation catalyst 30 may be structured to have any number of different types of flow-through designs. The oxidation catalyst 30 may be structured to oxidize at least some particulate matter in the exhaust (e.g., the soluble organic fraction of soot) and reduce unburned hydrocarbons and CO in the exhaust to less environmentally harmful compounds. For example, the oxidation catalyst 30 may be structured to reduce the hydrocarbon and CO concentrations in the exhaust to meet the requisite emissions standards for those components of the exhaust gas. An indirect consequence of the oxidation capabilities of the oxidation catalyst 30 is the ability of the oxidation catalyst to oxidize NO into NO2. In this manner, the level of NO2 exiting the oxidation catalyst 30 is equal to the NO2 in the exhaust gas generated by the engine 21 in addition to the NO2 converted from NO by the oxidation catalyst.

In addition to treating the hydrocarbon and CO concentrations in the exhaust gas, the oxidation catalyst 30 may also be used in the controlled regeneration of the particulate filter 40, SCR catalyst 50, and AMOx catalyst 60. This can be accomplished through the injection, or dosing, of unburned HC into the exhaust gas upstream of the oxidation catalyst 30. Upon contact with the oxidation catalyst 30, the unburned HC undergoes an exothermic oxidation reaction which leads to an increase in the temperature of the exhaust gas exiting the oxidation catalyst 30 and subsequently entering the particulate filter 40, SCR catalyst 50, and/or the AMOx catalyst 60. The amount of unburned HC added to the exhaust gas is selected to achieve the desired temperature increase or target controlled regeneration temperature.

The particulate filter 40 may be any of various flow-through designs, and is structured to reduce particulate matter concentrations (e.g., soot and ash) in the exhaust gas to meet requisite emission standards. The particulate filter 40 captures particulate matter and other constituents, and thus can be periodically regenerated to burn off the captured constituents. Additionally, the particulate filter 40 may be structured to oxidize NO to form NO2 independent of the oxidation catalyst 30.

As discussed above, the SCR system 52 includes a reductant delivery system with a reductant (e.g., DEF) source 54, pump (not shown), and delivery mechanism or doser 56. The reductant source 54 can be a container or tank capable of retaining a reductant, such as, for example, ammonia (NH₃), DEF (e.g., urea), diesel oil, etc. The reductant source 54 is in reductant supplying communication with the pump, which is structured to pump reductant from the reductant source 54 to the delivery mechanism 56 via a reductant delivery line 58. The delivery mechanism 56 is positioned upstream of the SCR catalyst 50. The delivery mechanism 56 is selectively controllable to inject reductant directly into the exhaust gas stream prior to entering the SCR catalyst 50. As described herein, the controller 100 is structured to control the timing and amount of the reductant delivered to the exhaust gas. The reductant may decompose to produce ammonia. As briefly described above, the ammonia reacts with NOx in the presence of the SCR catalyst 50 to reduce the NOx to less harmful emissions, such as N₂ and H₂O. The NOx in the exhaust gas stream includes NO₂ and NO. Both NO₂ and NO are reduced to N₂ and H₂O through various chemical reactions driven by the catalytic elements of the SCR catalyst in the presence of NH₃.

The SCR catalyst 50 may be any of various catalysts known in the art. For example, in some implementations, the SCR catalyst 50 is a vanadium-based catalyst, and in other implementations, the SCR catalyst is a zeolite-based catalyst, such as a Cu-Zeolite or a Fe-Zeolite catalyst. In one representative embodiment, the reductant is aqueous urea and the SCR catalyst 50 is a zeolite-based catalyst. In other embodiments, the reductant includes a first reductant and a second reductant, wherein the first reductant is urea and the second reductant is ammonia.

The AMOx catalyst 60 may be any of various flow-through catalysts structured to react with ammonia to produce mainly nitrogen. As briefly described above, the AMOx catalyst 60 is structured to remove ammonia that has slipped through or exited the SCR catalyst 50 without reacting with NOₓ in the exhaust. In certain instances, the aftertreatment system 22 can be operable with or without an AMOx catalyst. Further, although the AMOx catalyst 60 is shown as a separate unit from the SCR system 52 in FIG. 2, in some implementations, the AMOx catalyst may be integrated with the SCR catalyst (e.g., the AMOx catalyst and the SCR catalyst can be located within the same housing). In some embodiments, the SCR catalyst and AMOx catalyst are positioned serially with the SCR catalyst preceding the AMOx catalyst. As referred to herein, the SCR catalyst 50 and AMOx catalyst 60 form the SCR and AMOx system. Accordingly, health or degradations determined are in regard to those catalysts.

Various sensors, such as temperature sensors 32, NOx sensors 34, and flow sensors 36, may be strategically disposed throughout the exhaust aftertreatment system 22 (or other portions of the system 200) and may be in communication with the controller 100 and structured to monitor operating conditions of the system 200. In some cases, the flow sensor(s) 36 is positioned upstream of the engine 21. It should be understood that one or more pressure and a variety of other sensors (oxygen sensors, exhaust gas constituent sensors, NH3 sensors, and so on) may also be included in the system and disposed in a variety of locations. Further, the precise placement of the sensors is highly configurable such that the depicted configuration is not meant to be limiting.

The EGR system 70 is structured to recirculate exhaust gas back to an intake manifold of the engine 21 to be used for combustion. The EGR system 70 includes an EGR cooler 74 and an EGR valve 76. The EGR cooler 74 is structured as any type of heat exchanger typically included in EGR systems including, but not limited to, air-to-air and/or liquid (e.g., coolant)-to-air (e.g., exhaust gas) heat exchangers. The EGR cooler 74 is structured to remove heat from the exhaust gas prior to the exhaust gas being re-introduced into the intake manifold. Heat is removed from the exhaust gas prior to reintroduction to, among other reasons, prevent high intake temperatures that could promote pre-ignition (e.g., engine knock).

Although the exhaust aftertreatment system 22 shown includes one of a oxidation catalyst 30, particulate filter 40, SCR catalyst 50, and AMOx catalyst 60 positioned in specific locations relative to each other along the exhaust flow path, in other embodiments the exhaust aftertreatment system may include more than one of any of the various catalysts positioned in any of various positions relative to each other along the exhaust flow path. Additionally, although the oxidation catalyst 30 and AMOx catalyst 60 are non-selective catalysts, in some embodiments, the oxidation catalyst and AMOx catalyst can be selective catalysts. Further, the EGR system 70 may include other flow paths, or components not described above.

The operator I/O device 120 is communicably coupled to the controller 100, such that information may be exchanged between the controller 100 and the I/O device 120. The information exchanged between the controller 100 and the I/O device 120 may relate to one or more components of FIGS. 1-2 and/or any of the determinations of the controller 100 disclosed herein. The operator I/O device 120 enables an operator of the vehicle (or an occupant of the vehicle) to communicate with the controller 100 and other components of the vehicle, such as those illustrated in FIG. 2. For example, the operator input/output device 120 may include an interactive display, a touchscreen device, one or more buttons and switches, voice command receivers, etc. Additional, input, output, and/or input/output devices may be included, such as, a transmission shifter(s), an accelerator pedal, a brake pedal, a steering wheel, and so on.

The controller 100 is structured to control, at least partly, the operation of the system 200 and associated sub-systems, such as the internal combustion engine 21, fuel injector 18, ignition assist device 20, and the exhaust aftertreatment system 22 (e. g, doser 56, etc.). Communication between and among the components may be via any number of wired or wireless connections. For example, a wired connection may include a serial cable, a fiber optic cable, a CAT5 cable, or any other form of wired connection. In comparison, a wireless connection may include the Internet, Wi-Fi, cellular, radio, etc. In one embodiment, a controller area network (“CAN”) bus provides the exchange of signals, information, and/or data. The CAN bus includes any number of wired and wireless connections. Because the controller 100 is communicably coupled to the systems and components of FIGS. 1 and 2, the controller 100 is structured to receive data from one or more of the components shown in FIGS. 1 and 2. For example, the data may include CO data, NOx data, flow data, temperature data, or other data captured by the sensors 32, 34, 36, and vehicle operating data (e.g., engine speed, vehicle speed, engine temperature, etc.) received via one or more sensors. As another example, the data may include an input from operator input/output device 120. Further, the data may include fluid flow data (e.g., rate, amount, temperature, pressure, etc.), which can be measured or determined by an oxygen sensor (not shown) or other gas flow sensor.

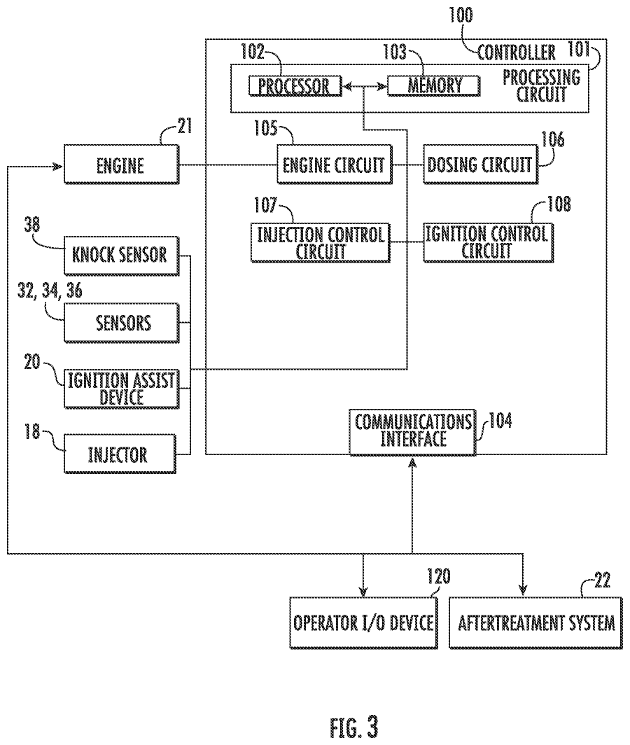

Referring now to FIG. 3, an example structure for the controller 100 is depicted, according to an example embodiment. The controller 100 is shown to include at least one processing circuit 101 including a processor 102, a memory 103, and various circuits including at least an engine circuit 105, a dosing circuit 106, an injection control circuit 107, and an ignition control circuit 108. The processor 102 may be implemented as one or more processors, application specific integrated circuit (ASICs), field programmable gate arrays (FPGAs), digital signal processors (DSPs), a group of processing components, or other suitable electronic processing components. The at least one memory 103 (e.g., RAM, ROM, Flash Memory, hard disk storage, etc.) may store data and/or computer code for facilitating the various processes described herein. The memory 103 may be communicably connected to the processor 102 and one or more circuits (e.g., engine circuit 105, dosing circuit 106, injection control circuit 107, or ignition control circuit 108) and structured to provide computer code or instructions to the processor 102 for executing certain of the processes described in regard to the controller 100 herein. Moreover, the memory 103 may be or include tangible, non-transient volatile memory or non-volatile memory. Accordingly, the memory 103 may include database components, object code components, script components, or any other type of information structure for supporting the various activities and information structures described herein.

The controller 100 is structured to receive inputs (e.g., signals, information, data, etc.) from the system 200 components/systems and/or operator I/O device 120. Thus, the controller 100 is structured to control, at least partly, the system 200 components/systems and associated vehicle. As the components of FIG. 3 can be embodied in a vehicle, the controller 100 may be structured as one or more electronic control units (ECUs). The controller 100 may be separate from or included with at least one of a transmission control unit, an exhaust aftertreatment control unit, a powertrain control module, an engine control module, etc.

In one configuration, one or more circuits (e.g., engine circuit 105, dosing circuit 106, injection control circuit 107, and ignition control circuit 108) can be embodied as machine or computer-readable media that stores instructions that are executable by a processor, such as processor 102, and stored in a memory device, such as memory 103. As described herein and amongst other uses, the machine-readable media facilitates performance of certain operations to enable reception and transmission of data. For example, the machine-readable media may provide an instruction (e.g., command, etc.) to, e.g., acquire data. In this regard, the machine-readable media may include programmable logic that defines the frequency of acquisition of the data (or, transmission of the data). The computer readable media may include code, which may be written in any programming language including, but not limited to, Java or the like and any conventional procedural programming languages, such as the “C” programming language or similar programming languages. The computer readable program code may be executed on one processor or multiple remote processors. In the latter scenario, the remote processors may be connected to each other through any type of network (e.g., CAN bus, etc.).

In another configuration, the one or more circuits are embodied as hardware units, such as electronic control units. As such, the one or more circuits may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on). The one or more circuits may also include programmable hardware devices such as field programmable gate arrays, programmable array logic, programmable logic devices or the like. The one or more circuits may include one or more memory devices for storing instructions that are executable by the processor(s) of the individual circuits (e.g., engine circuit 105, dosing circuit 106, injection control circuit 107, or ignition control circuit 108). The one or more memory devices and processor(s) may have the same definition as provided herein with respect to the memory 103 and processor 102. In some hardware unit configurations, the one or more circuits may be geographically dispersed throughout separate locations in the system (e.g., the vehicle). Alternatively and as shown, the one or more circuits may be embodied in or within a single unit/housing, which is shown as the controller 100.

In various arrangements, the controller 100 includes a communications interface 104. The communications interface 104 may include any combination of wired and/or wireless interfaces (e.g., jacks, antennas, transmitters, receivers, transceivers, wire terminals) for conducting data communications with various systems, devices, or networks structured to enable in-vehicle communications (e.g., between and among the components of the vehicle) and, in some embodiments, out-of-vehicle communications (e.g., directly with at least one remote computing system). In this regard, in some embodiments, the communications interface 104 includes a network interface. The network interface is used to establish connections with other computing devices by way of the network. The network interface includes program logic that facilitates connection of the controller 100 to the network. The network interface includes any combination of a wireless network transceiver (e.g., a cellular modem, a Bluetooth transceiver, a Wi-Fi transceiver) and/or a wired network transceiver (e.g., an Ethernet transceiver). For example, the communications interface 104 includes a wireless device such as a cellular transceiver and machine-readable media such as a cellular driver configured to facilitate connections with the network. In some arrangements, the network interface includes the hardware and machine-readable media sufficient to support communication over multiple channels of data communication. Further, in some arrangements, the network interface includes cryptography capabilities to establish a secure or relatively secure communication session in which data communicated over the session is encrypted. For example and regarding out-of-vehicle/system communications, the communications interface 104 may include an Ethernet card and port for sending and receiving data via an Ethernet-based communications network and/or a Wi-Fi transceiver for communicating via a wireless communications network. The communications interface 104 may be structured to communicate via local area networks and/or wide area networks (e.g., the Internet) and may use a variety of communications protocols (e.g., IP, LON, Bluetooth, ZigBee, and radio, cellular, near field communication). Furthermore, the communications interface 104 may work together or in tandem with a telematics unit, if included, in order to communicate with other vehicles in the fleet and/or the remote computing system. In one example embodiment, the communications interface 104 is structured provide vehicle information (e.g., operational parameters and/or operational data) to a remote computing system, a third party computing systems, and/or other vehicles in a fleet. In other embodiments, this network connectivity/communication aspect may be excluded.

In the example shown, the controller 100 includes the processing circuit 101 that may be structured or configured to execute or implement the instructions, commands, and/or control processes described herein with respect to the engine circuit 105, dosing circuit 106, injection control circuit 107, and ignition control circuit 108. The depicted configuration represents the engine circuit 105, dosing circuit 106, injection control circuit 107, and ignition control circuit 108 as instructions in machine or computer-readable media. In some embodiments, the instructions may be stored by the memory device. However, as mentioned above, this illustration is not meant to be limiting as the present disclosure contemplates other embodiments where the engine circuit 105, dosing circuit 106, injection control circuit 107, and ignition control circuit 108, or at least one of these circuits, is configured as a hardware unit. All such combinations and variations are intended to fall within the scope of the present disclosure.

The engine circuit 105 is structured to receive information from a user (e.g., via the operator input/output device 120, accelerator pedal, etc.) and to provide instructions to or otherwise control the engine 21. For instance, the engine circuit 105 is configured to control the engine itself and components associated with the engine including at least the intake valve for controlling an amount of intake air, the exhaust valve to release the exhaust gas through the pipe (e.g., piping 24, 28A-C, 26, etc.), or other components of the engine 21. Additionally, the engine circuit 105 may control a torque and/or speed from the engine 21. The engine circuit 105 is structured to receive information associated with the engine 21, such as fueling amount, engine temperature, fuel flow rate (e.g., air-fuel mixture flow rate), etc.

The dosing circuit 106 is structured to control the doser 56. In this way, the dosing circuit 106 is configured to provide a dosing command to the doser 56 to control and manage (e.g., adjust) reductant dosing amount and/or timing from the doser 56. The dosing circuit 106 may also communicate with one or more other circuits, such as the injection control circuit 107. For example, the dosing circuit 106 can receive information from at least one of the processing circuit 101 or the injection control circuit 107 regarding an amount of fuel injected into the engine 21 at various times (e.g., during various drive cycle times).

The dosing circuit 106 identifies or receives information regarding a value of the fuel or fuels for the engine, such as a ratio of the amounts of different types of fuel (e.g., 50% hydrogen and 50% natural gas, etc.). As such, depending on the value, such as the ratio or quantity of each type of fuel, the dosing circuit 106 can increase or decrease the dosing of reductant to reduce one or more combustion byproducts (e.g., NOx, etc.) from the engine 21. For example, with a relatively higher ratio/level/quantity/amount of hydrogen introduced into the fuel mixture (e.g., a hydrogen amount or value being above a predefined threshold, such as above 40%, etc.), the dosing circuit 106 provides a dosing command to the doser 56 to decrease the reductant dosing amount because less NOx is produced from burning hydrogen such that less reductant may be needed to reduce NOx to less harmful elements. Alternatively, for example, with a relatively lower ratio of hydrogen in the mixture (e.g., the hydrogen amount for combustion being below the predefined threshold), the dosing circuit 106 can maintain (or increase) the reductant dosing amount.

In various arrangements, the dosing circuit 106 commands the doser 56 to reduce the dosage of reductant proportional to the hydrogen content. Because hydrogen produces less NOx when combusted, less reductant is needed to achieve the desired amount NOx decrease or minimization (i.e., to keep NOx emissions at or below a predefined level or threshold). The dosing circuit 106 can command the doser 56 to reduce the dosage of reductant proportional to the hydrogen content, such that the greater amount or ratio of hydrogen content introduced in the fuel mixture, the less reductant is dosed into the exhaust aftertreatment system.

The injection control circuit 107 is structured or configured to control the fuel injector 18. The injection control circuit 107 may control the injection of at least one of the fuels from multiple fuel sources/tanks by injecting one fuel after another or concurrently by injecting multiple fuels at the same instance. In one embodiment, there may be dedicated fuel injectors for each fuel type which are each controlled by the injection control circuit 107. In some implementations, the injection control circuit 107 is structured to inject a desired amount of fuel based on power (e.g., torque) demand from the engine circuit 105. For the purposes of providing examples herein, the first fuel may refer to a primary fuel type used for the engine 21, such as natural gas, among others, and the second fuel may refer to a secondary fuel used for substituting the primary fuel, such as hydrogen, for example. In some other cases, the first fuel may be the secondary fuel and the second fuel may be the primary fuel. For example, depending on the desired power output by the engine 21 (e.g., controlled by the engine circuit 105), the injection control circuit 107 is structured to inject the fuel accordingly, such as to increase the injection rate for a relatively higher desired output or decrease the injection rate for a relatively lower desired output (e.g., depending on the current power output demand and injection rate).

In some implementations, for relatively higher power output demand, the injection control circuit 107 is structured to command the injector 18 to increase the injection rate of the first fuel and/or decrease the injection rate of the second fuel. For instance, hydrogen fuel can enhance the energy efficiency of the ignition assist device, however, for relatively higher torque demands for the engine 21 (e.g., above a predefined threshold), it may be desired for a relatively higher amount or ratio of the primary fuel to be provided to the engine 21 (e.g., natural gas). Hence, the injection rate of the hydrogen fuel may be commanded to decrease (or remain the same) with a command to increase the injection rate of the primary fuel.

In various implementations, the injection control circuit 107 is structured to adjust an injection parameter value (e.g., injection amount, injection rate, injection timing, injection duration, frequency, etc.) based on an indication of an engine knock or a misfire condition. The engine knock or misfire condition may be indicated by a signal from the knock sensor 38, for example. The signal from the knock sensor 38 can be processed by the processing circuit 101, among other circuits of the controller 100. In some cases, the engine knock may indicate that (or be representative of) the value (e.g., an amount or a ratio, etc.) of at least one of the fuels being greater than a (e.g., predefined) threshold. The threshold can be one of a plurality of thresholds, such as 10%, 20%, 30%, 40%, or 50%, etc., of hydrogen content in the fuel mixture. Each threshold may correspond to a respective setting of one or more components, such as the injector 18 or the ignition assist device 20. The various thresholds and their associated configuration settings can be stored in a table or determined via a process executed by the controller 100 (e.g., a table look-up). The configuration setting refers to a value or range of values for at least one control parameter of the component or system, such as the injector or ignition assist device. The thresholds can be stored in the memory 103 for local access or on a remote data repository for remote access.

As an example, the thresholds can include at least a first threshold (e.g., 10%) and a second threshold (e.g., 20%) regarding the content of hydrogen in the fuel mixture. The first threshold can be associated with a first set of parameter configurations for the injector 18 or the ignition assist device 20, such as a first adjustment to at least one of the ignition timing, the ignition energy, the ignition profile, the first fuel injection rate, and/or the second fuel injection rate, etc. The second threshold can be associated with a second set of parameter configurations for the injector 18 or the ignition assist device 20, such as a second adjustment to at least one of the ignition timing, the ignition energy, the ignition profile, the first fuel injection rate, or the second fuel injection rate, etc.

As another example, due to the presence of an engine knock indicator and based on the operating characteristic of the engine 21 (e.g., engine speed, air or fuel intake flow rate, temperature, etc.), the injection control circuit 107 and/or the ignition control circuit 108 may adjust at least one parameter of the injector 18 or the ignition assist device 20. The injection control circuit 107 and/or ignition control circuit 108 may continuously adjust operation of the injector and/or ignition assist device until the knock signal dissipates. For example and given the high combustibility of hydrogen, the injection control circuit 107 may reduce hydrogen injections in sequential predefined amounts until the knock signal dissipates. As another example and still given the high combustibility of hydrogen, the ignition control circuit 108 may reduce the ignition energy to reduce a likelihood of undesired combustion until the knock signal dissipates. It should be understood that a combination of parameters for the injector(s) and ignition assist device(s) may be adjusted.

In some scenarios, the value of the fuel may be regarding the primary fuel (e.g., amount, ratio, etc.). The ignition energy can be adjusted based on the value reaching a particular threshold. For example, if the value is greater than a predefined high threshold (e.g., 90%) of primary fuel content, relatively higher ignition energy (e.g., 30 mJ of energy) can be adjusted or configured for the ignition assist device 20 (e.g., the higher threshold can be associated with the higher ignition energy adjustment in this case). In this regard, more ignition energy may be required to achieve the desired combustion characteristics given the low content of the secondary (in this case, hydrogen) fuel. In another example, if the value is greater than a medium predefined threshold of primary fuel (e.g., 60%), relatively lower ignition energy (e.g., 20 mJ of energy) can be adjusted or configured for the ignition assist device 20. In this instance and due to the high combustibility of hydrogen, relatively lower ignition energy may be required given the relatively greater amount of hydrogen.

In some other scenarios, the threshold(s) can be associated with the ignition timing or at least one ignition profile. In this regard and given the value regarding at least one of the fuels, the ignition control circuit 108 may adjust at least one of the ignition timing or ignition profile of at least one ignition assist device for the engine to achieve or attempt to achieve a desired operating characteristic (e.g., carbon emissions below a threshold, performance goals, etc.). For example, with a relatively higher threshold (e.g., 90% of primary fuel), the ignition timing may be adjusted (e.g., by the ignition control circuit 108) to be more frequent (e.g., a multi-spark command enabled) to promote combustion. In another example, with a relatively lower threshold (e.g., 60% of primary fuel), the ignition timing may be adjusted to be less frequent (e.g., multi-spark command disabled). In the scenarios above and in addition to these controls, the injection control circuit 107 may be structured to adjust the injection rate of the primary fuel or secondary fuel based on the value regarding at least one of the fuels being greater than or equal to the threshold (or based on an indication of engine knock from a knock or combustion misfire value).

The misfire condition may indicate that the value of primary fuel (e.g., pressure, amount, or ratio) is less than a threshold regarding the fuel mixture (e.g., less than 70%, etc.), or the hydrogen content is greater than or equal to another threshold (e.g., greater than or equal to 30%, etc.). For instance, the injection control circuit 107 is structured to control the injector 18 to increase the amount of primary fuel or decrease the hydrogen content in the mixture in response to receiving the indication of a misfire condition. In this case, the injection control circuit 107 is structured to adjust the fuel mixture such that the value is greater than the threshold. In various arrangements, the injection control circuit 107 is structured to communicate with or operate in conjunction with the ignition control circuit 108 to resolve the engine knock or misfire condition.

In some cases, the injection control circuit 107 controls or adjusts the fuel injection timing of one or more of the fuels (primary and/or secondary; or others if more than two-fuel capable engine) based on the flow rate of one or more of the fuels for the engine 21. The flow rate is sensed by one or more flow sensors 36. The injection control circuit 107 may increase the injection frequency or duration of the first fuel based on a corresponding to decrease in injection of the second fuel, and vice versa. The injection control circuit 107 can provide an indication of the injection timing of at least one of the first fuel or the second fuel (among other fuels used for the engine 21) to the ignition control circuit 108, among other circuits. In some cases, a relatively higher flow rate may indicate a relatively higher frequency of fuel injection (e.g., fuel injection timing), and a relatively lower flow rate may indicate a relatively lower frequency of fuel injection. In some other cases, the injection control circuit 107 determines, at least in part, the value of regarding at least one of the first fuel or the second fuel based on the flow rate and the injection timing of the fuels. For example, based on the injection timing of the fuel(s) (e.g., duration, frequency, occurrences/instances, etc.), the injection control circuit 107 can determine the amount of the fuel(s) injected at the location of the injector 18 and the duration until the fuel reaches the combustion chamber according to the flow rate, for example.

The ignition control circuit 108 is structured or configured to control or manage one or more parameters or operation/operating parameters of the ignition assist device. The one or more parameters can include at least one of ignition/spark energy, an ignition timing, an ignition/spark profile, capability combination thereof, among others. The ignition control circuit 108 is structured to adjust the one or more parameters of the ignition assist device based on the amount of primary and/or secondary fuel (e.g., hydrogen) injected in the engine 21 (e.g., upstream of or within the combustion chamber of the cylinder 12).

In some implementations, the ignition control circuit 108 controls the ignition assist device 20 to adjust (e.g., increase or decrease) the ignition timing (e.g., instance at which ignition occurs during the combustion stroke) based on the value of at least one of the first fuel or the second fuel. For example, the value can include an amount of the first fuel and/or the second fuel, a proportion/ratio between the fuels, a fuel pressure of the first fuel and/or the second fuel, and/or other indications regarding one or both of the fuels. The value may be a value of hydrogen content (e.g., based on measurements from a gas or fuel sensor, commands to the fuel injector 18, or injection timing and flow rate, among others). The determined or received value of hydrogen content can be compared to a threshold. The determined hydrogen content may be a content at a particular time instant (e.g., responsive to the fuel injection, when the fuels reach the cylinder 12 or the combustion chamber, etc.), over a time period (e.g., over one or more duty or drive cycles, an absolute amount of time such as 30 seconds, etc.), and/or over a distance traveled (e.g., vehicle travel distance, etc.), The threshold can be predetermined/predefined, for example, based on the specification of the engine 21 (e.g., make, model, etc.), tests performed for the particular engine 21, and/or data from comparable engines 21.

In some cases, if the hydrogen content is greater than or equal to the predefined threshold, the ignition control circuit 108 retards the ignition timing (e.g., retard by a predefined amount based on how much the hydrogen content exceeds the threshold, where the greater the hydrogen content results in more retardation employed) of the ignition assist device 20 relative to a currently used ignition timing. In some cases, the threshold can be a continuum (or includes various thresholds). For instance, based on the increase in hydrogen content, the ignition control circuit 108 is structured to retard the ignition timing according to the respective thresholds (e.g., the higher the hydrogen content, the more retardation of the ignition timing). In some other cases, the ignition control circuit 108 can advance the ignition timing based on the primary fuel content being greater than a threshold. For example, in the presence of high charge temperatures (temperatures above a predefined high temperature threshold) where the addition of H2 to NG makes the ignition delay shorten, the ignition control circuit 108 may advance spark timing so that the flame can consume the fuel in the end gas before it has a chance to auto ignite (knock). This is because adding H2 to NG causes the ignition delay to get shorter. Because the flame speed of H2 is so much faster than NG, once the flame starts propagating, it clears the cylinder quickly. However, if the mixture was close to being ready to auto ignite (based on detection of a hot spot, hot charge, etc. from one or more sensors, such as temperature sensors), the ignition control circuit 108 may advance spark timing to keep it from happening before the flame can consume it. When a cylinder is cold (temperature from a temperature sensor or model being below a predefined low temperature threshold), the ignition control circuit 108 may advance spark timing to ensure complete combustion and/or better efficiency. Substituting hydrogen fuel when the cylinder is cold may allow a relatively more thermodynamically optimal spark timing, thereby resulting in better efficiency.

In various implementations, the ignition control circuit 108 is structured or configured to adjust the ignition energy based on the hydrogen content. For example, if the value regarding the hydrogen content is greater than or equal to the threshold (e.g., an amount or ratio of hydrogen at an instance, over time, etc., which may be dependent upon the engine power output, elevation, load, etc.), the ignition control circuit 108 is structured to reduce the ignition energy. In this regard, the higher the hydrogen content, the less ignition energy is required for combustion. Hence, by reducing the ignition energy according to the amount of hydrogen in the fuel mixture, the useful life of the ignition assist device 20 can be extended (e.g., 30% decrease in ignition energy can extend the life of the ignition assist device 20 by a correlating amount). The decrease in ignition energy may be proportional to the ratio of the hydrogen content. For instance, the ignition control circuit 108 may reduce/decrease the ignition energy by 10% for 7% of hydrogen, 20% of ignition energy for 15% of hydrogen, 30% of ignition energy for 22% of hydrogen, etc. As the hydrogen content decreases, the ignition control circuit 108 may increase the ignition energy level.

In some arrangements, the ignition control circuit 108 is structured to adjust the ignition profile based on the determined hydrogen content in the mixture (e.g., upstream of or in the combustion chamber). For example, the ignition control circuit 108 is structured to enable or disable a multi-spark capability of the ignition assist device based on the detected, identified, or otherwise determined hydrogen content. For instance, the ignition control circuit 108 may enable multi-spark capability when no hydrogen content has been determined or when the value (e.g., amount, ratio, percentage, etc.) of hydrogen content is below a predefined threshold. In response the value of hydrogen being greater than (or equal to) the predefined threshold, the ignition control circuit 108 is structured to disable the multi-spark capability to reduce the total ignition energy output by the ignition assist device 20 given the relatively high combustibility of hydrogen fuel such that the total energy expenditure for the ignition assist device may be reduced. The spark intensity and/or duration from the ignition assist device may be controlled by the ignition control circuit 108 based on the determined hydrogen value.

As discussed herein, the value regarding at least one of the first fuel or the second may correspond to, for example, at least one of an amount of the first fuel and/or the second fuel, the ratio between the first and second fuels, the fuel pressure of the first fuel and/or the second fuel, the fuel flow rate of the first and/or second fuels, among other indications associated with at least one of the first and second fuels for the engine 21. In one embodiment, the value refers to an amount of hydrogen (second fuel) for the engine 21. The controller 100 can determine or estimate the value of hydrogen content based on an indication of engine knock or combustion misfire. The controller 100 is structured to communicate with the knock sensor 38 (e.g., accelerometer or audio sensor) to receive an indication regarding at least one of the engine knock or combustion misfire. Engine knock refers to combustion occurring at unintended times. The knock or misfire condition may be determined based on a torque output, an acceleration rate of the crankshaft, and/or an exhaust manifold pressure pulse, among others. For example, if a torque increase is detected that is offset from a combustion event, this may indicate a knock or misfire condition. An indication that the engine knock or misfire condition occurs may indicate that too much hydrogen has been injected into the engine system. In this case, at least one of the injection control circuit 107 or the ignition control circuit 108 can control the injector 18 or the ignition assist device 20, respectively, to minimize occurrences of knock or misfire. For instance, the injection control circuit 107 may command or control the injector 18 to adjust the hydrogen injection rate or primary fuel injection rate by a predefined amount. In another example, the ignition control circuit 108 may adjust at least one parameter of the ignition assist device, such as adjusting the ignition timing, ignition energy, etc. by a predefined amount (e.g., adjust the ignition timing such that the combustion is closer to the top dead center (retard ignition timing) or further from the top dead center (advance ignition timing)), or adjust the ignition energy to a predefined amount (e.g., 30 mJ) for low hydrogen content or another predefined amount (e.g., 10 mJ) for high hydrogen content, etc. After the one or more adjustments of the parameter(s), the controller 100 may not receive or there may be an absence of a signal from the knock sensor 38 (e.g., indicating no occurrence of knock or misfire). The amount or ratio of hydrogen relative to natural gas may be based on NOx or ammonia slip, in some embodiments as described herein, while in others, the ratio may be based on knock (e.g., presence or absence of a knock signal from the knock sensor). With a faster flame speed for hydrogen as compared to natural gas, the ignition control circuit 108 may retard spark timing with increasing amounts or ratios of hydrogen to avoid or mitigate knock. The amount of retardation may, in some embodiments, be linearly proportionally to the amount of hydrogen (increase in a linear amount based on the increase in amount or ratio of hydrogen). In other embodiments, a different correlation may be used. As another example, if knock is detected or an indicator of a likelihood of knock (e.g., presence of hot spots, etc.), the information associated with the knock or indicator of knock may be correlated to an amount of hydrogen (e.g., relatively higher hydrogen content may correspond with a greater likelihood of knock).

In some aspects, after determining the value regarding at least one of the fuels, the controller 100 may perform or execute a process to determine a control parameter for at least one of the ignition assist device and/or injector. For example, the controller 100 may retrieve and utilize a lookup table using the value (e.g., ratio or amount of hydrogen) as an input with ignition energy (for the ignition assist device) and fuel injection amount (for the injector) as outputs, among others. While this example explains the table as being two-dimensional, in other embodiments, other inputs may also be used (e.g., requested torque output, etc.) as well as other outputs determined. In this way, the table can indicate various parameters that can be used to adjust the injector 18 or the ignition assist device 20 based on the value.

In some other embodiments, if the fuel injection occurs upstream of the cylinder 12 (e.g., instead of in-chamber), such as in a port fuel injected (PFI) design engine, the controller 100 may determine the value of the fuels entering the chamber based on the injection rate and/or the flow rate. For example, the controller 100 identifies the fuel injection timing (e.g., duration, instances, frequency, etc.) and the position/location of the respective injector 18 injecting at least one of the fuels. The controller 100 receives a signal from a flow sensor upstream from the cylinder 12, where the signal indicates the flow rate. As such, based on the flow rate (e.g., the rate the fuel flows from the injector 18 to the cylinder 12) and the fuel injection timing, the controller 100 determines the value regarding fuel that is entering the chamber. In some cases, as more hydrogen (e.g., zero-carbon fuel) is introduced (e.g., substituting the primary fuel) into the pipeline (for a pipeline-fed engine), the controller 100 can advance the primary fuel PFI for mixing with hydrogen and for volume efficiency.

In some implementations, the engine 21 may include at least one fuel sensor (e.g., gas sensor, hydrogen sensor, etc.) configured to detect the hydrogen content, among other characteristics of the fuel, such as a fuel type (e.g., natural gas, diesel, etc.). In this case, the controller 100 obtains or acquires the value regarding one or more fuels based on information extracted from the signal of the fuel sensor. In some other cases, the injection control circuit 107 is structured to control the injector 18 such that the injector 18 injects a predefined amount of fuel at a certain injection rate, duration, frequency, etc. In such cases, the controller 100 may receive an indication of the amount of the first and second fuels injected into the engine. In certain cases, the fuel may be injected directly into the combustion chamber (e.g., using the in-chamber injector shown in FIG. 1). In this case, the controller 100 can identify the value based on the injection rate of the fuel(s) controlled by the injection control circuit 107.

In some cases, a hydrogen sensor is included upstream from the engine 21, at the engine 21, and/or downstream from the engine 21, such as within the exhaust manifold or further downstream from the exhaust manifold (e.g., in the aftertreatment system 22), for example. The controller 100 receives the readings/measurements from the hydrogen sensor indicating the amount of hydrogen in the exhaust gas mixture (when disposed downstream of the engine 21) and/or as a part of the charge for the engine (when disposed upstream of the engine 21 or in the engine 21). The controller 100 is configured to adjust one or more components of the system 200 to increase the air supplied into the engine 21 in response to an increase in hydrogen content or decrease the air into the engine 21 in response to a decrease in the hydrogen content, for example.

Once the value is determined or obtained, the controller 100 may indicate the value to the one or more circuits, such as the injection control circuit 107 or the ignition control circuit 108. In some cases, the controller 100 (e.g., processing circuit 101) compares the value to the threshold to determine whether at least one parameter of the injector 18 or the ignition assist device 20 is to be adjusted. Accordingly, the controller 100 is structured to minimize engine knock or misfire or improving the energy efficiency of the ignition assist device 20 (e.g., extends the useful life of the ignition assist device 20).

In some implementations, the hydrogen mixture may be predefined by the manufacturer (e.g., of the engine 21 or the system 200) (i.e., for what the engine must use to ensure proper operation at various conditions). For instance, the predefined amount of hydrogen injected into the engine system may depend on other variables of the system 200, such as power demand, level of emissions, or other variables. In this way, by knowing the operating conditions, the controller 100 may then determine the value of hydrogen using the predefined amounts.

In operation, with a relatively higher power demand, the injection control circuit 107 may instruct or command the injector 18 to inject less hydrogen. Further, the injection control circuit 107 may incrementally increase the hydrogen amount (e.g., increment of 5% up to 50%) for relatively lesser power demand. In another example, as the level of undesired emissions increases (e.g., NOx, greenhouse gases, particulate matter, etc.), the injection control circuit 107 may incrementally increase the hydrogen amount. To increase the hydrogen amount, the injection control circuit 107 may command a valve in the fuel line to open and/or the injector nozzle to open for hydrogen to be injected for a longer duration, or provide a command to open the valve or injector nozzle more frequently (e.g., more injections). Hence, the controller 100 may identify the value regarding at least the primary and hydrogen fuel injected in the engine system based on at least these variables.

In various implementations, the controller 100 (e.g., injection control circuit 107) can adjust the injection timing of at least one of the first fuel or the second fuel to maintain a target value or amount of air-to-fuel ratio (AFR). It should be understood that the present disclosure is applicable with a variety of fuel systems. In this way, the types of injection of the first type of fuel or the second type of fuel may include includes, for example, a fumigation style where fuel is injected upstream of the engine, a port-fuel injection (PFI) type where an injector(s) is disposed upstream of one or more of the intake valves and not in the cylinder(s), and/or direction injection (DI) wherein there is an injector(s) disposed in the cylinder to inject fuel directly into the cylinder, among others.

In some cases, the proportion of the hydrogen content and the primary fuel content may be adjusted by at least one of increasing or decreasing the hydrogen content and/or the primary fuel content in the fuel mixture for the engine 21. Adjusting this proportion can change the desired AFR, such as generating a relatively higher AFR for a relatively higher proportion of hydrogen content and a relatively lower AFR for a relatively lower proportion of hydrogen content. This accounts for the higher quantities of air needed for hydrogen combustion. In such cases, the controller 100 determines the amount of hydrogen injected. When increasing or decreasing the content of one of the fuels, the content of the other fuel may be decreased or increased, respectively, such as to maintain or substantially maintain a similar torque output by the engine 21. In some embodiments, the controller 100 maintains the content of the fuel when the content of the other type of fuel is adjusted. In some embodiments, the controller 100 can decrease the amount of hydrogen content and increase the primary fuel content to generate more torque for the engine 21, for example.

In some embodiments, the controller 100 may determine that an amount of hydrogen is greater than a threshold for various operating conditions (e.g., at specific AFRs, at certain altitudes, etc.). In this case, when more hydrogen is introduced into the mixture by way of fuel injection for a relatively longer duration, the controller 100 is configured to advance the injection timing (e.g., injection window) of hydrogen, thereby allowing relatively more time for mixing. The advancement of the injection timing for hydrogen can be based on the amount of hydrogen being injected. In some cases, if relatively less hydrogen is being injected, the controller 100 can delay the injection timing of hydrogen. In some embodiments, the duration of fuel injection may stay the same by adjusting the injection rate (or activating or deactivating one or more injectors depending on the configuration of the system 200) to introduce more fuel. In some embodiments, as more hydrogen is desired to be utilized, the controller 100 may advance the injection timing of hydrogen. When less hydrogen is desired to be utilized, the controller 100 may delay the injection timing of hydrogen. As another example and with less hydrogen content, the controller 100 may advance the injection timing of the primary fuel to increase the amount of the primary fuel at a certain instance or period of time while the hydrogen is less than or equal to the threshold.

In some implementations, the controller 100 may control or adjust the turbo charger (e.g., variable-geometry turbocharger (VGT)) to maintain or achieve the desired amount of AFR. In particular and in certain embodiments, the controller 100 may adjust operation of the VGT based on zero-carbon fuel substitution (e.g., based on the amount of hydrogen or other zero-carbon fuel substituting the primary fuel). The controller 100 may adjust the VGT to increase or decrease the pressure ratio (or flow) across the turbine to generate more or less boost depending on an amount of hydrogen content (e.g., at a time instance or overtime). To supply more air to the cylinder(s) of the engine 21, the controller 100 adjusts the VGT to generate more boost by increasing the rotation rate of the VGT compressor. As hydrogen content increases, the controller 100 may control and adjust the VGT to generate more boost, thereby supplying more air into the engine 21. As the hydrogen content decreases and less air is may needed for stoichiometric combustion, the controller 100 may adjust and control the VGT to generate relatively lower amounts of boost, for example.

In various embodiments, the primary fuel (e.g., natural gas, etc.) can be associated with a relatively lower AFR compared to the hydrogen fuel (e.g., AFR of hydrogen fuel for ignition). For example, the stoichiometric value can be 17:1 (e.g., air to fuel ratio) for pure natural gas, while the stoichiometric value can be 34:1 for pure hydrocarbon gas. In this case, by blending/mixing hydrocarbon with the primary fuel (e.g., natural gas, etc.), the stoichiometric value (e.g., AFR) for burning the fuel can be between 17:1 (e.g., richer, relatively less air to fuel) to 34:1 (e.g., leaner, relatively more air to fuel), depending on the proportion of the fuel contents. For a relatively leaner mixture (e.g., increase in proportion of hydrogen), the controller 100 is configured to command further closing of the VGT to generate relatively more boost in response to a relatively higher air demand. For a relatively richer mixture (e.g., decreases in proportion of hydrogen), the controller 100 is configured to command the VGT to further open to generate relatively less boost in response to a relatively lower air demand.

The controller 100 is configured to control various devices or components of the system 200 to increase or decrease air into the cylinder. The components vary based on the configuration of the system 200. The controller 100 may control the VGT to increase or decrease the supply of air into the engine 21. The controller 100 may control at least one additional turbocharger to increase or decrease the airflow to the desired level depending on the level of hydrogen substitution in the mixture. The airflow is increased with relatively more hydrogen content (e.g., proportion of hydrogen) and the airflow is decreased with relatively less hydrogen content. In some embodiments, the controller 100 is configured to control other sources (e.g., in similar or different manner thereof) to increase or decrease air supply to the engine 21. The other sources may include at least one of a supercharger, second turbocharger, externally supplied source of air (e.g., compressed air tank), etc.

In certain arrangements, to maintain or achieve the desired AFR amount, the controller 100 may adjust the positioning of the valve of the intake throttle of the engine 21 based on zero-carbon fuel substitution. Adjusting the positioning of the intake throttle valve may include opening or closing the intake throttle valve, changing position or angle of the valve, etc., to selectively increase or decrease the airflow into the engine 21. The intake throttle valve can be adjusted to allow more air into the engine 21, such as by widening or increasing the opening size or changing the position of the valve, for example. In some cases, the controller 100 adjusts the positioning of the intake throttle (e.g., reduce or narrow the opening of the intake throttle) to decrease the airflow as the amount of hydrogen content decreases, such as to compensate for the AFR difference as more hydrogen is introduced in the fuel mixture. In some other cases, the controller 100 adjusts the intake throttle to increase the airflow (e.g., widen the opening of the intake throttle) as the amount of hydrogen content increases to allow more air into the engine 21. The amount of opening or closing of the intake throttle valve may be proportional to the amount of hydrogen content, such that as the hydrogen content increases, the more the intake throttle valve opens to increase the air content. In other embodiments, a faster burn may be desired (e.g., during regeneration), such that the controller 100 does not close the intake throttle valve while the hydrogen content increases in order to keep relatively higher combustion temperatures for exhaust aftertreatment system regeneration.

In some implementations, the controller 100 is configured to control the VGT and the intake throttle simultaneously. To increase more air, the controller 100 can adjust the VGT to increase boost and/or increase the opening of the intake throttle to allow more air for combustion. To decrease the amount of air entering the engine 21, the controller 100 may adjust the VGT to decrease boost and/or reducing the opening of the intake throttle, thereby allowing less air to enter the engine 21.

In certain instances, increasing the hydrogen content into the fuel mix increases the flame speed during the combustion process in the cylinder 12. To compensate for the hydrogen flame speed or the increase in flame speed due to hydrogen mixture, the controller 100 is structured to adjust the variable valve timing (VVT) of at least one of the valves 16 (e.g., the intake valve(s) or exhaust valve(s)), in some embodiments. Adjusting the VVT refers to changing the timing when the valve opens and close by a certain amount. Advancing the VVT allows the air to enter the engine 21 relatively early, thereby potentially increasing the amount of air in the mixture. For example, the controller 100 can delay the VVT of the intake valve and/or advance the VVT of the exhaust valve to reduce scavenging of residual EGR. To compensate for the hydrogen flame speed, for example, the controller 100 can increase the trapped EGR (e.g., residuals) by advancing the VVT of the intake valve and/or delaying the VVT of the exhaust valve. The greater the amount of hydrogen (e.g., zero-carbon fuel substitution), the greater the magnitude of VVT adjustment, for example.

In certain implementations, the controller 100 adjusts the VVT to advance the timing of the valve or delay/retard the timing of the valve based on the hydrogen content in the fuel mixture. The controller 100 can advance the timing based on a relatively higher hydrogen content (e.g., amount of hydrogen above a certain threshold(s)). The controller 100 can delay the timing based on a relatively lower hydrogen content (e.g., amount of hydrogen decreases/lowers below the certain threshold(s)). Advancing the timing allows air to enter the engine 21 earlier, thereby increasing the amount of air in the mixture (e.g., AFR). On the contrary, delaying the timing results in the air entering the engine 21 relatively later, thereby decreasing the amount of air in mixture.

In various arrangements, the controller 100 adjusts the VVT to shift the intake and exhaust profile to provide a permanent or semi-permanent intake (e.g., maintain a certain amount of valve opening), thereby affecting the efficiency (e.g., volumetric efficiency) to the desired level. In this case, the controller 100 is configured to maintain the opening of the intake throttle, such as at a relatively low fuel supplied or injected. By maintaining the opening of the intake throttle, pumping loss can be avoided or reduced. A relatively higher volumetric efficiency corresponds to relatively higher fuel efficiency, and a relatively lower volumetric efficiency corresponds to relatively lower fuel efficiency. In some implementations, the controller 100 adjusts the VVT simultaneously with at least one of the intake throttle and/or VGT to increase or decrease air supply into the engine 21. In some implementations, the controller 100 controls the VGT and/or VVT instead of the intake throttle to avoid closing the intake throttle at a relatively lower fuel supplied, such that pumping loss can be avoided because the throttle valve remains open, for example. In some cases, the controller 100 adjusts the VVT to reduce pumping loss and provide compatibility in operating with different types of turbochargers (e.g., make, model, etc.) for the engine 21. In some implementations, at a relatively higher fuel supplied, there may be an excess of energy to spool the turbocharger. In such cases, the controller 100 controls the throttle valve to reduce its opening. In some embodiments, the system 200 may be configured with a relatively larger throttle body to support more air into the engine 21.

In some arrangements, the controller 100 is configured to control the variable valve actuation (VVA) of the valves in the engine 21. The controller 100 adjusts the profile of the VVA (e.g., by controlling the camshaft(s)) to further increase the opening of the intake valves. Similarly, the controller 100 may adjust the profile of the VVA to decrease the opening of the intake valve. The controller 100 is configured to control the VVA of the valves in the engine 21 to adjust the timing, duration, and/or lift of the valves. The implementation of the VVA may depend on the configuration of the engine 21. Hence, the controller 100 may adjust the VVA to increase the opening of the valves when more air is desired (e.g., more hydrogen content) and decrease the opening of the valves when less air is desired (e.g., less hydrogen content).

In various implementations, the engine 21 includes at least one cylinder pressure sensor (CPS) configured to provide real-time or near real-time combustion feedback data to the vehicle. The controller 100 is configured to receive the feedback data from the CPS for controlling combustion in the engine 21.

In some embodiments, with a relatively higher blend of hydrogen (e.g., amount of hydrogen content above a predefined threshold), the engine 21 may be susceptible to knock given the hydrogen substitution or content in the mixture. In turn, for the engine 21 that includes a variable compression ratio (VCR) system, the controller 100 is configured to control a connecting rod that enables adjustment of the compression ratio to avoid knocking or a likelihood of knocking. For a relatively lower amounts of hydrogen fuel with a relatively higher amounts of primary fuel content, the controller 100 is configured to use a relatively lower compression ratio to obtain an overall higher volumetric efficiency, such as 12:1 compression ratio. For a relatively higher amounts of hydrogen fuel with a relatively lower amounts of primary fuel, the controller 100 is configured to use a relatively higher compression ratio to obtain an overall lower volumetric efficiency, such as 16:1 compression ratio. The controller 100 varies the physical compression ratio such that in response to an increase in hydrogen content (e.g., relatively higher compression ratio), the VVT may be adjusted to reduce the compression ratio (e.g., to achieve a relatively higher volumetric efficiency in this case), for example.

In some embodiments that have a VCR system, the controller 100 uses the feedback data from the CPS to operate the engine 21 at the desired efficiency level according to fuel compositions, speed, and/or load of the engine 21, etc. In response to changes to the fuel composition, internal residual from the boundary condition variation, among other conditions of the engine 21, the controller 100 can change the combustion phasing/timing according to the variations to such conditions. In this regards, the controller 100 is configured to use the CPS and VCR concurrently to achieve the desired combustion phasing, thereby avoiding knock, for example. In certain implementations, the CPS can reduce the cycle-to-cycle variation and/or detect knock, which enables the controller 100 to control the operation of the engine 21 more consistently and at a higher efficiency level.

As described herein, the more hydrogen content is blended with the primary fuel (e.g., natural gas), the more the AFR varies (in particular, the more air desired). To control the target lambda (e.g., AFR) according to the amount of hydrogen content, the controller 100 is configured to use a flame speed compensator (e.g., knock sensor) in response to knock level when adjusting the AFR. If a knock is detected (e.g., auto-ignition), the controller 100 uses a feedback technique (e.g., indicating that a knock occurred, such as due to hydrogen content increase) to adjust the one or more components of the system 200, such that the knock is resolved or mitigated. The adjustments of the one or more components to resolve the knock can be associated with the amount of hydrogen content in the mixture.

In some cases, to control the target lambda, the controller 100 is configured to use the CPS in response to changes to the fuel mixture (e.g., more or less hydrogen content). In this case, the engine 21 is equipped or structured with at least one CPS. With the CPS, the controller 100 can optimize the combustion by adjusting at least one of the VVT, compression ratio, spark energy, VGT, etc., to obtain or achieve the desired pressure level (e.g., combustion pressure) in the cylinder of the engine 21. The adjustments to the one or more components of the system 200 can reflect or be associated with the hydrogen content in the mixture.

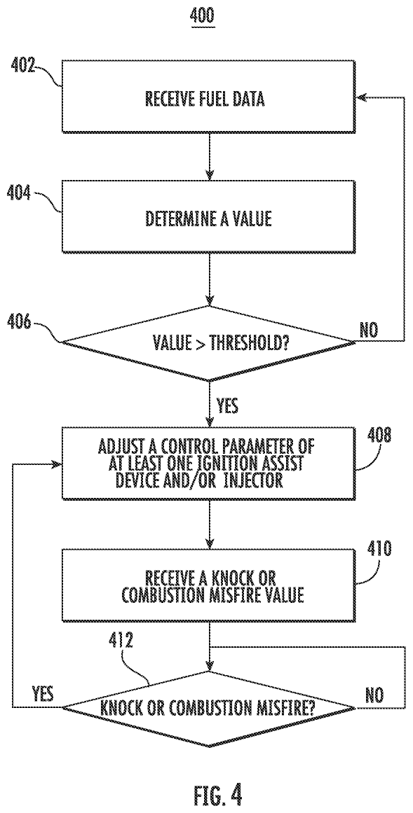

Based on the foregoing and referring now to FIG. 4, a flow diagram of a method 400 for adjusting an ignition assist device parameter is shown, according to an example embodiment. The method 400 may be performed by the components of FIGS. 1-3, such that reference may be made to them to aid explanation of the method 400. Discussed hereinafter, the method 400 includes processes 402-412, among other processes (or other operations) to control the fuel injector (e.g., injector 18) and/or the ignition assist device (e.g., ignition assist device 20), or manage other components of the system (e.g., system 200). In various implementations, certain processes can be performed before or after one another.

At process 402, the controller 100 receives fuel data for an engine 21 coupled to at least one ignition assist device 20. The fuel data can include a value regarding at least one of a first fuel or a second fuel for the engine. In one embodiment, the first fuel is different from the second fuel. For instance, one of the first fuel or the second corresponds to a hydrogen fuel, while the other one of the first fuel or the second fuel corresponds to another fuel type configured for the engine 21, such as natural gas, among others.

In various implementations, the controller 100 may receive or obtain the fuel data from signal(s) from at least one fuel injector 18. For example, the engine system may include a first fuel injector and a second fuel injector (or a single fuel injector coupled to multiple fuel tanks). In this case, the controller 100 receives a first signal from the first fuel injector indicating an amount of the first fuel injected into the engine 21 or the combustion chamber of the cylinder 12. The controller 100 receives a second signal from the second fuel injector indicating an amount of the second fuel injected into the engine. As such, the value may correspond to the amount of at least one of the first fuel or the second fuel. In other embodiments, the value may correspond to the pressure associated with the amount of the respective fuel, the ratio regarding the amount of the first fuel relative to the amount of the second fuel (or vice versa), and/or other characteristics regarding the fuel or mixture of fuels for the engine.

At process 404, the controller 100 determines the value regarding at least one of the fuels. For instance, the engine 21 can include a flow sensor. The controller 100 receives a signal from the flow sensor 36 indicative of a fuel flow rate for at least one of the first fuel or the second fuel for the engine 21. Based on the fuel flow rate, the controller 100 determines a first fuel injection timing of the first fuel (e.g., timing of the first fuel injected or introduced in the combustion chamber according to the fuel flow rate). Also based on the fuel flow rate, the controller 100 determines a second fuel injection timing of the second fuel. In some cases, the fuel injection timing is further based on the location or position of the injector 18 upstream of the cylinder 12. For instance, the farther upstream the position of the injector 18, the longer it takes for the injected fuel to reach the combustion chamber (e.g., also considering the combustion cycle). Hence, based on the first fuel injection timing and the second fuel injection timing (e.g., when each fuel is injected or reached the combustion chamber), the controller 100 determines the value regarding the at least one of the first fuel or the second fuel. In this case, the value may refer to the amount of fuel injected according to the injection timing, the ratio of the fuels injected based on the amount of the first and second fuels, or the amount of at least one of the fuels injected.

In various arrangements, the controller 100 determines the value based on adjustments to at least one parameter for at least one injector or ignition assist device, such as discussed in conjunction with at least one of processes 408, 410, 412. For example, an engine knock or combustion misfire may occur as hydrogen is introduced into the fuel mixture. The controller 100 identifies at least one of current operating characteristic of the engine 21 (e.g., engine speed, manifold pressure, etc.), the current parameters of the ignition assist device 20 (e.g., ignition energy, ignition timing, ignition profile, etc.), and/or the current parameters of the injector 18 (e.g., injection duration, injection occurrences, etc., indicated by the injection control circuit 107). The controller 100 (e.g., at least one of the injection control circuit 107 or the ignition control circuit 108) can adjust at least one of the parameters of the ignition assist device 20 or the injector 18 and monitor changes to the operation of the engine 21, such as occurrences or non-occurrences of engine knock or combustion misfire. If the adjustment resolves the knock or misfire, the controller 100 can identify the value regarding the first fuel or second fuel that is associated with at least one of the adjustment(s) made to one or more parameters or the changes to the operating characteristic of the engine 21. For example, based on the adjustment(s) made, the controller 100 determines an amount or a ratio of hydrogen present to resolve the knock or misfire in the engine 21. In this example, the adjusted parameter may include at least one of an ignition timing (e.g., advance or retard by a certain rate), an ignition energy (e.g., ignition energy for a good combustion), an ignition profile (e.g., whether single-spark or multi-spark command is used), a fuel injection timing, a fuel flow rate, and/or others, each of which may be included in a configuration setting associated with a respective value (e.g., 10%, 20%, 30%, etc., of hydrogen content).

In some implementations, the engine 21 includes a fuel or gas sensor structured to measure the concentration or amount of individual fuel types entering the combustion chamber (e.g., a hydrogen sensor). In this case, the controller 100 receives a signal from the fuel sensor. Based on the signal, the controller 100 determines the value regarding the first fuel or the second fuel. In this example, the value regarding the fuels refers to the amount or mass of fuel traversing past the sensor for a certain duration (e.g., 10 ms, 100 ms, 1 second, etc.).

At process 406, the controller 100 determines whether the value is greater than (or equal to) a predefined threshold. In this example, the value refers to a hydrogen content of a fuel for the engine 21. As such, the threshold corresponds to a predefined amount of hydrogen (which may be based on certain operating parameters of the engine, such as altitude, load, etc.). The predefined threshold may prompt an adjustment of at least one parameter of at least one component of the system 200, such as the injector 18, the ignition assist device 20, the doser 56, among others. There may be multiple thresholds (e.g., continuum of thresholds), where crossing or reaching each threshold can trigger respective adjustment of at least one parameter.

In various arrangements, the controller 100 may determine that the value is less than the threshold. In this case, the controller 100 can continue monitoring or receiving fuel data (e.g., return to process 402). In some other cases, the controller 100 determines that the value is greater than (or equal to) the predefined threshold. Accordingly, the controller 100 proceeds to process 408.

At process 408, the controller 100 (e.g., the ignition control circuit 108) adjusts at least one parameter of the at least one ignition assist device 20 (or injector 18, such as by the injection control circuit 107) based on the determined value being greater than the predefined threshold. Adjusting the at least one parameter may refer to or correspond to controlling, configuring, setting, adjusting, or modifying (e.g., at least one operation of) the component associated with the parameter, which may include at least one ignition assist device, at least one injector, and/or another system and/or component (e.g., a doser, an engine such as an engine speed and/or torque (the parameter), etc.). The at least one control parameter of the ignition assist device 20 can include at least one of an ignition energy, an ignition timing, or an ignition profile of the ignition assist device 20. The ignition energy can include at least one of an amplitude or a duration of the ignition energy. The ignition profile can include at least one of a single strike ignition or a multi-strike ignition. For example, based on the value being greater than the predefined threshold, the controller 100 may reduce the ignition energy. The controller 100 may reduce the ignition energy proportional to the hydrogen content in the fuel mixture, as less ignition energy is required for the combustion of hydrogen fuel, for example. In this case, by reducing the ignition energy, ignition assist device 20 can be more energy efficient and its useful life can be extended.

In another example, the controller 100 may retard the ignition timing based on the value being greater than the predefined threshold. For instance, as hydrogen content in the fuel mixture increases, the combustion rate of the fuels may be comparatively faster. Therefore, the controller 100 can (e.g., further) retard the ignition timing as more hydrogen is used.

In various implementations, the controller 100 may adjust one or more operating parameters of injector 18 in addition or alternatively to the ignition assist device 20. For example, the controller 100 determines that the value regarding at least one of the first fuel or the second fuel is greater than (or equal to) a second predefined threshold. In this case, the second predefined threshold may be greater than the predefined threshold, such that another adjustment can be made (or this adjustment can be made instead of the prior adjustment). Based on the value being greater than (or equal to) the second predefined threshold, the controller 100 adjusts an injection amount of one of the first fuel or the second fuel. For instance, the controller 100 may reduce the hydrogen content if excessive hydrogen content is introduced or increase the primary fuel content in the mixture. In another example, the controller 100 may further adjust at least one parameter (e.g., similar or different parameter adjusted when the value exceeds the predefined threshold) of the ignition assist device 20 if the value is greater than the second predefined threshold.

At process 410, the controller 100 receives a knock or combustion misfire value. The knock or combustion misfire value indicates whether there is an engine knock or combustion misfire. For example, the controller 100 can receive the knock or combustion misfire value from a knock sensor indicating a true state (e.g., “1” value) or a false state (e.g., “0” value). In some cases, the value can indicate whether at least one engine knock or at least one combustion misfire occurs. In certain aspects, the knock or combustion misfire value may be represented by the presence or absence of a signal from the knock sensor.

At process 412, based on the knock or combustion misfire value, the controller 100 determines whether there is an engine knock or combustion misfire event (e.g., due to hydrogen content in the fuel mixture). If no knock or combustion misfire occurs, the controller 100 can continue monitoring for such events (e.g., loop process 412). In some cases, the controller 100 may return to process 402 to determine additional value regarding at least one of the first fuel or the second fuel if no knock or combustion misfire occur.

In some other cases, the controller 100 receives a signal from the knock sensor indicative of the engine knock or misfire condition. As such, the controller 100 can return to process 408 to further adjust at least one or another parameter of one or more components, such as the injector 18 or the ignition assist device 20. For example, in response to the engine knock or combustion misfire, the controller 100 may initiate, in response to receiving the signal, another adjustment of at least one parameter using a configuration setting (among other configuration settings) for the ignition assist device 20. Each configuration setting can be associated with a respective value regarding at least one of the first fuel or the second fuel. For instance, as the value changes (e.g., more or less hydrogen content introduced), a respective configuration setting is selected or used to adjust the parameter. As the value increases which may result in engine knock or combustion misfire, the associated configuration setting may indicate to further retard the ignition timing, reduce ignition energy, change the ignition profile, or decrease an injection of the first fuel or the second fuel (e.g., decrease the hydrogen content), in some cases.

In some implementations, the controller 100 monitors the changes in the operating characteristic of the engine 21 and/or the knock or combustion misfire value received from the knock sensor after the adjustment to the parameter. If the controller 100 identifies, subsequent to another adjustment, an absence of another signal indicative of the engine knock or misfire condition (e.g., the knock or misfire condition is false), the controller 100 determines, based on the configuration setting used for the another adjustment, a subsequent value regarding at least one of the first fuel or the second fuel. For instance, because the adjustment to the parameter results in no engine knock or combustion misfire, the controller 100 determines an updated value regarding at least one of the fuels. The determination can be based on at least one of the previous value, operating characteristics of the engine 21, or the parameters of the component(s) prior to the adjustment, and the operating characteristics of the engine 21, or the parameters of the component(s) after the adjustment.

In various implementations, the controller 100 (e.g., injection control circuit 107) may control the injector 18 to increase an injection of one of the first or second fuel (e.g., hydrogen) based on the absence of another signal. For example, the controller 100 may determine that an engine knock or combustion misfire does not occur. As such, the controller 100 may increase the hydrogen mixture to reduce carbon emissions, reduce ignition energy, etc.

In various arrangements, if an engine knock or combustion misfire occurs, the controller 100 may decrease an injection of the first fuel or the second fuel (e.g., hydrogen content). In various other arrangements, if no engine knock or combustion misfire occurs (e.g., absence of a signal from a knock sensor indicative of an engine knock or misfire condition), such as after adding hydrogen in the mixture, the controller 100 may further increase an injection of one of the first fuel or the second fuel.

It should be understood that no claim element herein is to be construed under the provisions of 35 U.S.C. §112(f), unless the element is expressly recited using the phrase “means for.” The schematic flow chart diagrams and method schematic diagrams described above are generally set forth as logical flow chart diagrams. As such, the depicted order and labeled steps are indicative of representative embodiments. Other steps, orderings and methods may be conceived that are equivalent in function, logic, or effect to one or more steps, or portions thereof, of the methods illustrated in the schematic diagrams. Further, reference throughout this specification to “one embodiment”, “an embodiment”, “an example embodiment”, or similar language means that a particular feature, structure, or characteristic described in connection with the embodiment is included in at least one embodiment of the present invention. Thus, appearances of the phrases “in one embodiment”, “in an embodiment”, “in an example embodiment”, and similar language throughout this specification may, but do not necessarily, all refer to the same embodiment.

Additionally, the format and symbols employed are provided to explain the logical steps of the schematic diagrams and are understood not to limit the scope of the methods illustrated by the diagrams. Although various arrow types and line types may be employed in the schematic diagrams, they are understood not to limit the scope of the corresponding methods. Indeed, some arrows or other connectors may be used to indicate only the logical flow of a method. For instance, an arrow may indicate a waiting or monitoring period of unspecified duration between enumerated steps of a depicted method. Additionally, the order in which a particular method occurs may or may not strictly adhere to the order of the corresponding steps shown. Further, various steps may be included or omitted from the depicted method or process and still fall within the scope of the present disclosure.

Many of the functional units described in this specification have been labeled as circuits, in order to more particularly emphasize their implementation independence. For example, a circuit may be implemented as a hardware circuit comprising custom very-large-scale integration (VLSI) circuits or gate arrays, off-the-shelf semiconductors such as logic chips, transistors, or other discrete components. A circuit may also be implemented in programmable hardware devices such as field programmable gate arrays, programmable array logic, programmable logic devices or the like.

As mentioned above, circuits may also be implemented in machine-readable medium for execution by various types of processors, such as processor 102 of FIG. 3. An identified circuit of executable code may, for instance, comprise one or more physical or logical blocks of computer instructions, which may, for instance, be organized as an object, procedure, or function. Nevertheless, the executables of an identified circuit need not be physically located together, but may comprise disparate instructions stored in different locations which, when joined logically together, comprise the circuit and achieve the stated purpose for the circuit. Indeed, a circuit of computer readable program code may be a single instruction, or many instructions, and may even be distributed over several different code segments, among different programs, and across several memory devices. Similarly, operational data may be identified and illustrated herein within circuits, and may be embodied in any suitable form and organized within any suitable type of data structure. The operational data may be collected as a single data set, or may be distributed over different locations including over different storage devices, and may exist, at least partially, merely as electronic signals on a system or network.

The computer readable medium (also referred to herein as machine-readable media or machine-readable content) may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing. As alluded to above, examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. As also alluded to above, computer readable program code embodied on a computer readable signal medium may be transmitted using any appropriate medium, including but not limited to wireless, wireline, optical fiber cable, Radio Frequency (RF), or the like, or any suitable combination of the foregoing. In one embodiment, the computer readable medium may comprise a combination of one or more computer readable storage mediums and one or more computer readable signal mediums.

For example, computer readable program code may be both propagated as an electro-magnetic signal through a fiber optic cable for execution by a processor and stored on RAM storage device for execution by the processor.

Computer readable program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The computer readable program code may execute entirely on the user's computer (such as via the controller 100 of FIGS. 1 and 2), partly on the user's computer, as a stand-alone computer-readable package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

Accordingly, the present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. A system, comprising:
at least one ignition assist device;
a controller coupled to the at least one ignition assist device, the controller configured to:
receive fuel data for an engine coupled to the at least one ignition assist device, the fuel data comprising a value regarding at least one of a first fuel or a second fuel for the engine, the first fuel differing from the second fuel;
determine that the value regarding the at least one of the first fuel or the second fuel is greater than a predefined threshold; and
adjust at least one parameter of the at least one ignition assist device based on the determined value being greater than the predefined threshold.

2. The system of claim 1, wherein the controller is further configured to:
receive a signal from a knock sensor indicative of an engine knock or misfire condition; and
initiate, in response to receiving the signal, another adjustment of the at least one parameter of the at least one ignition assist device using a configuration setting of a plurality of configuration settings for the at least one ignition assist device, each of the plurality of configuration settings is associated with a respective value regarding at least one of the first fuel or the second fuel, wherein the another adjustment decreases an injection of the first fuel or the second fuel.

3. The system of claim 2, wherein the controller is further configured to:
identify, subsequent to the another adjustment, an absence of another signal indicative of the engine knock or misfire condition; and
determine, in response to the absence of the another signal and based on the configuration setting used for the another adjustment, a subsequent value regarding the at least one of the first fuel or the second fuel; or
increase, based on the absence of another signal, an injection of one of the first fuel or the second fuel.

4. The system of claim 1, wherein the value corresponds to an amount of the fuel first or the second fuel.

5. The system of claim 1, wherein the value corresponds to a ratio regarding an amount of the first fuel relative to an amount of the second fuel.

6. The system of claim 1, wherein the controller is further configured to:
receive, from a flow sensor, a signal indicative of a fuel flow rate for at least one of the first fuel or the second fuel for the engine;
determine, based on the fuel flow rate, a first fuel injection timing of the first fuel;
determine, based on the fuel flow rate, a second fuel injection timing of the second fuel; and
determine, based on the first fuel injection timing and the second fuel injection timing, the value regarding the at least one of the first fuel or the second fuel.

7. The system of claim 1, wherein one of the first fuel or the second fuel corresponds to a hydrogen fuel.

8. The system of claim 1, wherein the at least one parameter of the at least one ignition assist device comprises at least one of an ignition energy, an ignition timing, or an ignition profile of the at least one ignition assist device.

9. The system of claim 8, wherein the ignition energy comprises at least one of an amplitude or a duration of the ignition energy.

10. The system of claim 8, wherein the ignition profile comprises at least one of a single strike ignition or a multi-strike ignition.

11. The system of claim 8, wherein in adjusting the at least one parameter, the controller is configured to:
reduce the ignition energy based on the value being greater than the predefined threshold; or
retard the ignition timing based on the value being greater than the predefined threshold.

12. The system of claim 8, wherein in adjusting the at least one parameter, the controller is further configured to:
determine that the value regarding the at least one of the first fuel or the second fuel is greater than a second predefined threshold, the second predefined threshold greater than the predefined threshold; and
adjust, based on the value being greater than the second predefined threshold, an injection amount of one of the first fuel or the second fuel.

13. The system of claim 1, further comprising a first fuel injector and a second fuel injector, wherein the controller is configured to:
receive a first signal from the first fuel injector indicating an amount of the first fuel injected into the engine; and
receive a second signal from the second fuel injector indicating an amount of the second fuel injected into the engine.

14. The system of claim 1, wherein the controller is configured to at least one of:
receive a signal from a knock sensor indicative of an engine knock or misfire condition; and
decrease, in response to receiving the signal, an injection of the first fuel or the second fuel; or
identify an absence of a signal from a knock sensor indicative of an engine knock or misfire condition; and
increase, based on the absence of the signal, an injection of one of the first fuel or the second fuel.

15. A method comprising:
receiving, by a controller coupled to an ignition assist device, fuel data for an engine coupled to the ignition assist device, the fuel data comprising a value regarding at least one of a first fuel or a second fuel for the engine, the first fuel differing from the second fuel;
determining, by the controller, that the value regarding the at least one of the first fuel or the second fuel is greater than a predefined threshold; and
adjusting, by the controller, at least one parameter of the ignition assist device based on the determined value being greater than the predefined threshold.

16. The method of claim 15, further comprising:
receiving, by the controller, a signal from a knock sensor indicative of an engine knock or misfire condition; and
initiating, by the controller, in response to receiving the signal, an adjustment of the at least one parameter of the ignition assist device using a configuration setting of a plurality of configuration settings for the ignition assist device, each of the plurality of configuration settings is associated with a respective value regarding at least one of the first fuel or the second fuel;
wherein the respective value regarding the at least one of the first fuel or the second fuel comprises at least one of an amount of the fuel first or the second fuel or a ratio regarding an amount of the first fuel relative to an amount of the second fuel.

17. The method of claim 15, further comprising:
receiving, by the controller, a signal from a knock sensor indicative of an engine knock or misfire condition; and
decreasing, by the controller, in response to receiving the signal, an injection of the first fuel or the second fuel; or
identifying, by the controller, an absence of a signal from a knock sensor indicative of an engine knock or misfire condition; and
increasing, by the controller, based on the absence of the signal, an injection of one of the first fuel or the second fuel.

18. An apparatus, comprising:
one or more processors; and
one or more memory devices coupled to the one or more processors, the one or more memory devices storing instructions that, when executed by the one or more processors, cause the one or more processors to:
receive fuel data for an engine coupled to an ignition assist device, the fuel data comprising a value regarding at least one of a first fuel or a second fuel for the engine, the first fuel differing from the second fuel;
determine that the value regarding the at least one of the first fuel or the second fuel is greater than a predefined threshold; and
adjust at least one parameter of the ignition assist device based on the determined value being greater than the predefined threshold.

19. The apparatus of claim 18, wherein the value regarding the at least one of the first fuel or the second fuel for the engine comprises at least one of an amount of the fuel first or the second fuel or a ratio regarding an amount of the first fuel relative to an amount of the second fuel.

20. The apparatus of claim 18, wherein the at least one parameter of the ignition assist device comprises at least one of an ignition energy, an ignition timing, or an ignition profile of the ignition assist device, and wherein in adjusting the at least one parameter, the instructions, when executed by the one or more processors, further cause the one or more processors to:
reduce the ignition energy based on the value being greater than the predefined threshold; or
retard the ignition timing based on the value being greater than the predefined threshold.
